(19) United States
(12) Patent Application Publication
(10) Pub. No.: US 2018/0201242 A1
(43) Pub. Date: Jul. 19, 2018

(54) Method for performing closed-loop control of a motor vehicle and electronic brake control unit

(71) Applicant: Continental Teves AG & Co. oHG, Frankfurt (DE)

(72) Inventors: Kai Bretzigheimer, Mainz (DE); Stefan Feick, Bad Soden (DE)

(73) Assignee: Continental Teves AG & Co. oHG, Frankfurt (DE)

(21) Appl. No.: 15/919,567

(22) Filed: Mar. 13, 2018

Related U.S. Application Data
(63) Continuation of application No. PCT/EP2016/071616, filed on Sep. 14, 2016.

(30) Foreign Application Priority Data
Sep. 14, 2015 (DE) 10 2015 217 490.5
Sep. 14, 2016 (DE) 10 2016 217 465.7

(51) Int. Cl. B60T 8/1755

(52) U.S. Cl. CPC B60T 8/17557; B60T 2201/083; B60T 2201/087; B60T 2201/085; B60W 2520/14

(57) ABSTRACT

A method for performing closed-loop control of a motor vehicle having a brake system with a stability control system comprises comparing an actual yaw rate with a setpoint yaw rate which is calculated using a model. A yaw moment of a closed-loop or open-loop assistance control of an assistance system for lane guidance or transverse guidance is taken into account during the calculation of the setpoint yaw rate. An electronic brake control unit which is suitable for carrying out the method and is connected to at least one vehicle sensor, in particular a steering angle sensor, yaw rate sensor and/or wheel rotational speed sensors. The brake control unit can bring about, through actuation of actuators, a driver-independent increase in and a modulation of the braking forces at the individual wheels of the vehicle.

### CROSS-REFERENCE TO RELATED APPLICATION

This application claims the benefit of PCT Application PCT/EP2016/071616, filed Sep. 14, 2016, which claims priority to German Patent Application 10 2016 217 465.7, filed Sep. 14, 2016 and German Patent Application 10 2015 217 490.5, filed Sep. 14, 2015. The dis-closures of the above applications are incorporated herein by reference in their entirety.

### TECHNICAL FIELD

The invention relates to a method for performing control of a motor vehicle with an electronic brake control unit.

### BACKGROUND

Document DE 101 30 663 A1 discloses a method for driving stability control of a vehicle, in which method the input variables which are composed essentially of the predefined steering angle and the velocity are converted on the basis of a vehicle model into a setpoint value of the yaw velocity, and the latter is compared with a measured actual value of the yaw velocity.

Document DE 101 37 292 A1 discloses a driver assistance system for a motor vehicle having a servo-assisted steering system for lane guidance and/or lane keeping.

In the known motor vehicles, the lane keeping assistance is interrupted when a driving stability control system (ESP control system) starts.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

A method for performing control of a motor vehicle brake system, which permits stabilization of the vehicle and maintenance of lane guidance or trajectory guidance, in particular of cornering.

A closed-loop or open-loop assistance controller of an assistance system for lane guidance or lane keeping or transverse guidance makes available a yaw moment, and takes into account the latter during the calculation of a setpoint yaw rate for a driving stability control system of the motor vehicle.

The control interventions, in particular driving stability control interventions (ESP interventions) which impede or hinder the closed-loop or open-loop assistance control of the assistance system are avoided. Further, in the case of an ESP intervention the closed-loop or open-loop assistance control, in particular the lateral control or movement by the assistance system does not have to be interrupted.

The assistance system is a system for performing, at least temporarily, automated or semi-automated guidance of a vehicle, wherein in particular at least one sensor system for detecting the surroundings of the vehicle is provided.

The system may be an assistance system, e.g. lane guidance assistance system, for a motor vehicle having an electronic power steering system.

The assistance system supports the driver of the motor vehicle during driving along a determined setpoint trajectory, wherein a deviation of the motor vehicle from the setpoint trajectory is corrected by automatic correction steering movements and/or correction braking interventions, including braking interventions on one side. The motor vehicle is therefore kept on the setpoint trajectory.

The closed-loop control of the motor vehicle may involve a driving stability control (ESC: electronic stability control) system which acts in a stabilizing fashion on the motor vehicle during dynamic driving maneuvers through targeted braking interventions.

This may also be used for transverse guidance and/or for open-loop control of a motor vehicle.

According to one embodiment, the yaw moment is a requested setpoint yaw moment of the closed-loop or open-loop assistance control. The yaw moment may be a yaw moment which is requested by a lateral controller of the assistance system. In this way, an adjustment of the yaw moment which is requested by the assistance system is supported by the control system.

According to one embodiment, the yaw moment is a yaw moment which is actually output, in particular during the closed-loop or open-loop assistance control.

The yaw moment which is actually output is determined by considering the actual braking force which is made available at the brakes, and the moment which results therefrom. By taking into account the yaw moment which is actually implemented, allowance is made for the actual implementability of the request. The implementability can be limited, for example, by the rate of the buildup of pressure in the brake system or by an inability to output the yaw moment on the road in the case of a low coefficient of friction.

According to one embodiment, the yaw moment which is actually output is calculated from the brake pressures of a left-hand and right-hand wheel of a vehicle axle.

According to one embodiment, a steering angle and a vehicle velocity, in particular a vehicle reference velocity of the driving stability control system, are taken into account in the model for calculating the setpoint yaw rate. The steering angle represents here yawing of the vehicle which is desired by the driver and is to be taken into account.

According to one embodiment, an actual steering angle and the yaw moment are taken into account in the model for calculating the setpoint yaw rate. These may be input variables of the model.

According to another further embodiment, the yaw moment is converted into a corresponding steering angle which is added to an actual steering angle.

According to another further embodiment, the sum of the corresponding steering angle and actual steering angle is taken into account in the model for calculating the setpoint yaw rate. This may be an input variable of the model.

The steering angle which corresponds to the yaw moment is treated as a virtual steering angle of the assistance system. The addition of the virtual steering angle to the actual steering angle permits the request of the assistance system to be taken into account.

According to another further embodiment, the setpoint yaw rate is calculated by a controller, in particular a lateral controller, of the assistance system, and is made available to the driving stability controller.

Other objects, features and characteristics of the present invention, as well as the methods of operation and the functions of the related elements of the structure, the combination of parts and economics of manufacture will become more apparent upon consideration of the following detailed description and appended claims with reference to the accompanying drawings, all of which form a part of this specification. It should be understood that the detailed description and specific examples, while indicating the preferred embodiment of the disclosure, are intended for purposes of illustration only and are not intended to limit the scope of the disclosure.

### BRIEF DESCRIPTION OF THE DRAWINGS

Further embodiments of the invention will emerge from the subclaims and the following description with reference to FIGURES.

In the FIGURES:

FIG. 1 schematically shows a controller structure for carrying out an exemplary method.

### DETAILED DESCRIPTION

In addition to the steering system, the direction of movement of a vehicle can be changed by braking torques on one side. This may be used to implement assistance systems which prevent the vehicle from leaving the lane or roadway or colliding with another vehicle in the blind spot when cutting out.

For automated driving—e.g. traffic jam assistant—the vehicle can be kept in the lane in the event of failure of the power steering system by braking interventions on one side until the driver has taken back control of the vehicle.

The driving stability control system (ESP) may com-prise a yaw rate controller which compares a setpoint yaw rate with a measured yaw rate of the vehicle. When a specific deviation is exceeded, an ESP control intervention is triggered.

The setpoint yaw rate may be formed with the input variables of the steering angle and the vehicle velocity by means of a stable single-track vehicle model.

If the vehicle experiences a rotational movement as a result of braking of the wheels on one side (in particular by the assistance system for lane guidance or transverse guidance), even though the steering angle permits straight-ahead travel to be inferred, a deviation occurs between the ESP setpoint yaw rate and the measured yaw rate. When the control intervention threshold is exceeded, an ESP intervention then occurs which is unjustified since the vehicle is actually travelling in a stable fashion on the setpoint course. Therefore, unjustified ESP interventions are avoided.

A problematic situation occurs with other assistance systems as well, such as e.g. Road Departure Protec-tion, which is intended to turn the vehicle quickly back onto the roadway. Without further measures, the assistance system is interrupted by an ESP intervention in most cases.

It is therefore not possible to stabilize the vehicle and maintain the cornering at the same time.

In particular, during automated travel—that is to say in the fall-back level in the event of failure of the steering (failure of the power steering system)—cornering is not to be interrupted by an ESP intervention as result of the braking on one side (by the closed-loop or open-loop assistance control), since the vehicle could otherwise leave the roadway.

In order to avoid the ESP interventions, the ESP control thresholds could be made slightly wider. However, this would also have an effect on the “normal” ESP interventions.

Accordingly, during the formation or calculation of the setpoint yaw rate \dot{Ψ}_{ref}, the driving stability control system or the ESP evaluates not only the steering angle δ and the vehicle velocity v (or v_{ref}), but also the yaw moment MZ which is requested by the assistance system and/or is being currently implemented.

According to a first exemplary embodiment, the additional yaw moment M_{z} (from the closed-loop or open-loop assistance control) is input into a model for calculating the setpoint yaw rate, in particular into a single-track model.

The additional yaw moment M_{Z} may be input into the principle of angular momentum of the single-track model in addition to the two transverse forces at the front and rear wheels (F_{α,V}, F_{α,H}).

The exemplary single-track model is based on the following equations:

m·a_{y}=F_{α,V}·cos(δ)∓F_{α,G} Sliding equation:

J·\ddot{Ψ}=F_{α,V}·cos(δ)·l_{V}−F_{α,H}·l_{H}+M_{Z} Principle of angular momentum:

In this context the additional yaw moment M_{z} is taken into account as a summand in the calculation of the principle of angular momentum.

In this context:

$${F}_{α , V} = {c}_{V} \cdot {α}_{V}$$

$${F}_{α , H} = {c}_{H} \cdot {α}_{H}$$

$$v = \dot{Ψ} . \\ δ = \frac{l}{R} + {α}_{V} - {α}_{H} \\ {a}_{V} = β - \frac{{l}_{V}}{v} \cdot \dot{Ψ} + δ$$

$${α}_{H} = β + \frac{{l}_{H}}{v} \cdot \dot{Ψ}$$

where:

m: Mass of vehicle

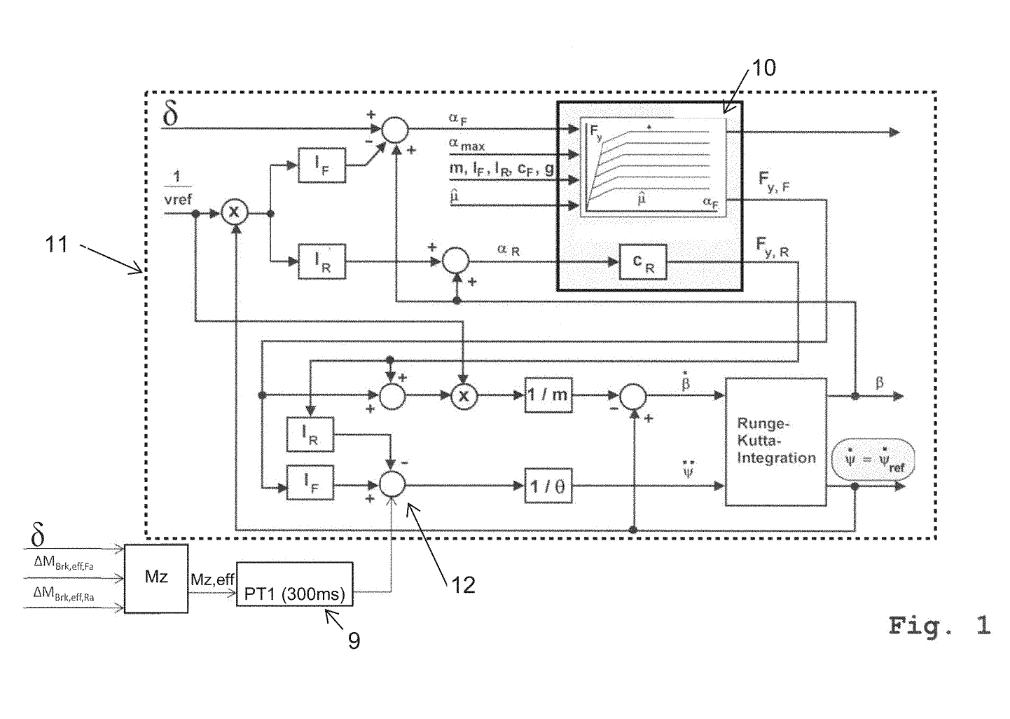

v: Vehicle velocity (v_{ref} in FIG. 1)

a_{y}: Vehicle transverse acceleration

α_{V}: Slip angle at front axle (α_{F} in FIG. 1)

α_{H}: Slip angle at front axle (α_{R} in FIG. 1)

β: Side slip angle

F_{α,V}: Transverse force at front axle (F_{y,F} in FIG. 1)

F_{α,H}: Transverse force at rear axle (F_{y,R} in FIG. 1)

c_{V}: Slip stiffness at front axle (c_{F} in FIG. 1)

c_{H}: Slip stiffness at rear axle (c_{R} in FIG. 1)

δ: Steering angle

\dot{Ψ}: Yaw rate

\ddot{Ψ}: Yaw acceleration

l_{V}: Distance between center of gravity and front axle (l_{F} in FIG. 1)

l_{H}: Distance between center of gravity and rear axle (l_{R} in FIG. 1)

M_{Z}: Additionally input yaw moment (M_{Z,eff} in FIG. 1)

J: Yaw inertia moment of the vehicle (θ in FIG. 1)

Here, the yaw moment requested by the lateral controller (of the assistance system) may be used for the yaw moment M_{z}, i.e. is input into the reference formation.

Alternatively, the yaw moment which is actually output is used for the yaw moment M_{z}, i.e. is input into the reference formation. In particular when the requested yaw moment cannot be implemented because the braking forces which can be output are physically limited.

The yaw moment which is actually output is calculated from the brake pressures of a left-hand and right-hand wheel of a vehicle axle.

In order to determine the actual yaw moment, for example the following procedure is adopted: A braking torque difference is calculated from the difference between the brake pressures at the left-hand wheel and those at the right-hand wheel of one axle. The braking moment differences are converted into two braking forces using the radii of the wheels. The braking forces are converted, using the half track widths, into two yaw moments u (ΔM_{Brk,eff,Fa} and ΔM_{Brk,eff,Ra}) which are subsequently added.

During the control process of the wheel slip controller, rapid changes can occur in the brake pressures. The brake pressures then no longer reflect the actual braking forces and the resulting change in the yaw rate of the vehicle. Therefore, filtering is carried out either of the wheel brake pressures or of the yaw moment calculated therefrom, in particular by means of a PT1 filter (block 9 in FIG. 1), in order to filter out the rapid changes. For example (FIG. 1), the time constant of the filter is 300 ms.

An exemplary calculation model for implementing the calculation of a single-track model is illustrated in FIG. 1. The model 11 additionally comprises taking into account the tire characteristic (block 10), i.e. the dependence of the transverse force on the slip angle.

According to the first exemplary embodiment, the yaw moment M_{Z} (or M_{Z,eff} in FIG. 1) is input directly into the single-track model, e.g. into the principle of angular momentum of the single-track model. Therefore, an additional input (yaw moment M_{z}) is added to the single-track model of the driving stability control system. This may be done in an adder 12.

In this way, the intended rotation of the vehicle by the assistance system is also taken into account in the ESP reference formation (setpoint yaw rate \dot{Ψ}_{ref}). The intended rotation of the vehicle by the assistance system is therefore not counteracted by an ESP intervention.

In addition, the ESP can detect an oversteering vehicle and counteract the oversteering without the rotation having to be entirely aborted.

According to a second exemplary embodiment of a method, as an alternative to direct inputting into the sin-gle-track model in the first exemplary embodiment, the yaw moment M_{z} is previously converted into a corresponding steering angle δᵥᵢᵣₜ.

For example, the following formula is used to cal-culate a virtual steering angle δᵥᵢᵣₜ:

$${δ}_{virt} = \frac{{c}_{V} + {c}_{H}}{{c}_{V} \cdot {c}_{H} \cdot ( {l}_{F} + {l}_{H} )} \cdot {M}_{Z}$$

The virtual steering angle δᵥᵢᵣₜ gives rise to the same steady-state yaw rate as the yaw moment M_{z}.

The steering angle δᵥᵢᵣₜ is added to the actual steering angle δ. The sum of the virtual steering angle δᵥᵢᵣₜ and the actual steering angle δ is then predefined to the single-track model. This avoids adding an additional input to the single-track model.

According to another embodiment of the method, the kinematic controller of the lateral closed-loop control (of the assistance system) calculates a setpoint yaw rate for the vehicle, in particular from the yaw moment M_{z}. When a driving stability control system (of an ESP intervention) is activated, the driving stability control system (yaw rate controller of the ESP) changes to this setpoint yaw rate of the assistance system.

The yaw moment which is requested and/or implemented by an assistance system is taken into account in the ESP reference formation.

As result, ESP interventions by the yaw rate controller which impede the assistance system in the execution are avoided.

Furthermore, the lateral movement does not have to be aborted with a possible ESP intervention.

The yaw moment may be converted by an additional input into the ESP reference formation.

Alternatively, the yaw moment is converted into a corresponding steering angle which is added to the actual steering angle.

The foregoing preferred embodiments have been shown and described for the purposes of illustrating the struc-tural and functional principles of the present invention, as well as illustrating the methods of employing the preferred embodiments and are subject to change without departing from such principles. Therefore, this invention includes all mod-ifications encompassed within the scope of the following claims.

What is claimed is:

1. A method for performing closed-loop control of a motor vehicle having a brake system with a driving stability control system comprising:
measuring an actual yaw rate;
calculating a setpoint yaw rate using a model, wherein a yaw moment of an assistance control of an assistance system for transverse guidance is taken into account; and
comparing the actual yaw rate with the setpoint yaw rate.

2. The method as claimed in claim 1, wherein the assistance control is one of a closed-loop and open-loop control.

3. The method as claimed in claim 1, wherein the assistance system for transverse guidance is one of a lane guidance and lane keeping.

4. The method as claimed in claim 1, wherein the yaw moment is one of: a requested setpoint yaw moment of the assistance control and an actual yaw moment which is output during the assistance control.

5. The method as claimed in claim 4, wherein the actual yaw moment which is actually output is calculated from the brake pressures of a left-hand and right-hand wheel of a vehicle axle.

6. The method as claimed in claim 1, wherein a steering angle and a vehicle velocity are taken into account in the model for calculating the setpoint yaw rate.

7. The method as claimed in claim 1, wherein an actual steering angle and the yaw moment are taken into account when calculating the setpoint yaw rate

8. The method as claimed in claim 7, wherein, the actual steering angle and the yaw moment are input variables of the calculation.

9. The method as claimed in claim 7, wherein the calculating is by is a single-track model, and the yaw moment is input into the principle of angular momentum of the single-track model.

10. The method as claimed in claim 1, wherein the yaw moment is converted into a corresponding steering angle which is added to an actual steering angle.

11. The method as claimed in claim 1, wherein the sum of the corresponding steering angle and actual steering angle is taken into account in the model for calculating the setpoint yaw rate, is an input variable of the model.

12. The method as claimed in claim 1, wherein the setpoint yaw rate is calculated by a controller of the assistance system, and is made available to the driving stability control system.

13. An electronic brake control unit comprising:
actuators, which are capable of driver-independent modulation of the braking forces at the individual wheels of the motor vehicle,
wherein the brake control unit is connected to at least one vehicle sensor and
a controller with instructions for:
measuring an actual yaw rate;
calculating a setpoint yaw rate using a model, wherein a yaw moment of an assistance control of an assistance system for transverse guidance is taken into account; and
comparing the actual yaw rate with the setpoint yaw rate.

14. The brake control unit of claim 13, wherein the at least one vehicle sensor is at least one of: a steering angle sensor, a yaw rate sensor, and wheel rotational speed sensors.

15. The brake control unit of claim 13, wherein the yaw moment is one of a requested setpoint yaw moment of the assistance control and an actual yaw moment which is output during the assistance control.

16. The brake control unit of claim 15, wherein the actual yaw moment is calculated from the brake pressures of a left-hand and right-hand wheel of a vehicle axle.

17. The brake control unit of claim 13, wherein a steering angle and a vehicle velocity are taken into account in the model for calculating the setpoint yaw rate.

18. The brake control unit of claim 13, wherein an actual steering angle and the yaw moment are taken into account when calculating the setpoint yaw rate

19. The brake control unit of claim 18, wherein the actual steering angle and the yaw moment are input variables of the calculation.

20. The brake control unit of claim 13, wherein the calculating is by is a single-track model, and the yaw moment is input into the principle of angular momentum of the single-track model.
